(19) United States
(12) Patent Application Publication
(10) Pub. No.: US 2007/0020764 A1
(43) Pub. Date: Jan. 25, 2007

(54) Method for processing chemistry and coagulation test samples in a laboratory workcell

(76) Inventor: Kerry Lynn Miller, Elkton, MD (US)

Correspondence Address: DADE BEHRING INC.;LEGAL DEPARTMENT, 1717 DEERFIELD ROAD, DEERFIELD, IL, 60015, US

(21) Appl. No.: 11/448,287

(22) Filed: Jun. 7, 2006

Related U.S. Application Data
(60) Provisional application No. 60/700,826, filed on Jul. 20, 2005.

(51) Int. Cl. G01N 35/00

(52) U.S. Cl. 436/45

(57) ABSTRACT

A method for automatically providing for classification of samples at the input station of a clinical laboratory workcell and allowing only those samples that have centrifuging requirements which are satisfied by currently established centrifuge operating protocols to be processed by a centrifuge and by an analyzer associated with said workcell.

### FIELD OF THE INVENTION

The present invention relates to an automated clinical sample handling workcell with two or more independent analyzers having samples supplied thereto by an automated conveyor system. More particularly, the present invention relates to a method for managing the different processes involved in pre-assay treatment of samples that require differential centrifuging prior to analysis by such analyzers within such an automated clinical sample handling workcell

### BACKGROUND OF THE INVENTION

A wide variety of automated chemical analyzers are known in the art and are continually being improved to increase analytical menu and throughput, reduce turnaround time, and decrease requisite sample volumes. Such improvements, while useful in themselves, may be hampered if sufficient corresponding advances are not made in the areas of pre-analytical sample preparation and handling. Sample preparation and handling includes sorting, batch preparation, centrifugation of sample tubes to separate sample constituents, cap removal to facilitate fluid access, and the like.

Automated sample preparation systems are commercially available and these generally include the use of conveyor systems for conveying specimens to clinical analyzers, such as those described in U.S. Pat. Nos. 5,178,834, and 5,209,903. A disadvantage of many of these conveyor systems is that they are an integrated and dedicated part of a total integrated system, which system includes special analyzers and other handling equipment. More universal sample handling systems have more recently been introduced, like that described in U.S. Pat. No.: 6,060,022, or in U. S. patent application Ser. No. 10/638,874, incorporated herein in its entirety by reference and these “workcells” are adapted to automatically treat clinical samples and to then present pre-treated samples in open containers to robotic devices operated in conjunction with independent stand-alone analyzers.

For purposes of certain laboratory clinical chemistry tests, plasma, obtained from whole blood by centrifugation, is most often used in the analysis. To prevent clotting, an anticoagulant such as citrate or heparin is added to the blood specimen immediately after it is obtained or the anticoagulant is present in the evacuated blood collection tube when the patient sample is originally obtained. The specimen is then centrifuged to separate plasma from blood cells. If desired, plasma may be frozen below −80° C. nearly indefinitely for subsequent analysis.

For many biochemical laboratory tests, plasma and blood serum can be used interchangeably. Serum resembles plasma in composition but lacks the coagulation factors. It is obtained by letting a blood specimen clot prior to centrifugation. For this purpose, a serum-separating tube may be used which contains an inert catalyst (such as glass beads or powder) to facilitate clotting as well as a portion of gel with a density designed to sit between the liquid and cellular layers in the tube after centrifugation, making separation more convenient.

Tests of coagulation require all clotting factors to be preserved. Serum, therefore, is inappropriate for these tests. A citrated evacuated blood collection tube is usually used, as the anticoagulant effects of citrate is dependent upon concentration and can be reversed for testing.

In addition, serum is preferred for many tests as the anticoagulants in plasma can sometimes interfere with certain analytical results. Different anticoagulants interfere with different tests; using serum means the same sample can be used for many tests. In protein electrophoresis, using plasma causes an additional band to be seen, which might be mistaken for a paraprotein.

Clinical chemistry diagnostic analyzers associated with such sample preparation systems are adapted to automatically perform chemical assays and immunoassays on biological samples such as urine, blood serum, plasma, cerebrospinal liquids and the like, these samples generally being contained in capped sample tubes. While capped, the samples may be subjected to a centrifuging operation to separate the sample's constituents prior to testing. Chemical reactions between an analyte in a patient's biological sample and reagents used to conduct the assay generate various signals that can be measured by the analyzer. From these signals the concentration of the analyte in the sample may be calculated.

Another type of sample analysis, coagulation tests, is used to diagnosis hemorrhagic conditions such as hemophilia, where one or more of the twelve blood clotting factors may be defective. Popular diagnostic tests are activated partial thromboplastin time (aPTT), prothrombin time (PT), and activated clotting time (ACT). Popular laboratory coagulation tests typically employ turbidimetric or other measuring techniques. For most coagulation tests, whole-blood samples are collected into a citrate vacutainer and then centrifuged to obtain a plasma sample. The assay is performed with plasma to which a sufficient excess of calcium has been added to neutralize the effect of citrate. The PT reported as time in seconds, represents how long a plasma sample takes to clot after a mixture of thromboplastin and calcium are added. The aPTT measures the clotting time of plasma, from the activation of factor XII by a reagent (a negatively charged activator such as silica and a phospholipid) through the formation of a fibrin clot. Activated clotting time (ACT) is test that is used to monitor the effectiveness of high dose heparin therapy. ACT tests however use undiluted blood from sites which have not been contaminated by heparin infusion. The whole blood sample is transferred to appropriate test vial, mixed with the activator and a timer activated on an ACT analyzer.

The overall analytical throughput of a laboratory may be increased by linking together analyzers of different types, each adapted to perform a certain menu of assays within a single workcell. However, a problem arises when both clinical chemistry and coagulation analyzes are linked to the same workcell because different centrifuging processes may be required to produce different properly separated samples for the different types of tests. From the above discussion it is evident that analytical tests may be performed on whole blood, plasma or serum, and that sometimes either plasma or serum may be used. Thus, different centrifugation processes may be required for different samples depending upon what tests are to be performed by which analyzers. Differential spin rates and lengths of time are examples of variables that make up what are hereinafter termed “centrifuge protocols” for different samples. Thus, while automated systems have advanced sample handling and processing throughput, what has not been addressed is the difficulty associated with handling samples that require differential centrifuging, different centrifuge protocols, within automated clinical sample handling workcells.

### SUMMARY OF THE INVENTION

The present invention provides for detecting and classifying patient samples at the input station of an automated clinical sample handling workcell with two or more independent coagulation and clinical chemistry analyzers prior to analysis and enabling only those samples that have pre-analysis centrifuging requirements which match the currently established centrifuge operating protocols to be subsequently processed by a centrifuge and an analyzer associated with said workcell. If a sample does not have centrifuging requirements which match the currently established centrifuge operating protocols, the sample is retained at the input station until the centrifuge operating protocols are changed appropriately. If a sample does have centrifuging requirements which match the currently established centrifuge operating protocols, the sample is processed in a routine manner by a centrifuge and then by either a chemistry analyzer or a coagulation analyzer depending upon whether the centrifuge is being operated with centrifuge protocols for clinical chemistry or coagulation testing.

### BRIEF DESCRIPTION OF THE DRAWINGS

For a better understanding of the invention as well as other objects and further features thereof, reference is made to the following detailed description of various preferred embodiments thereof, taken in connection with the accompanying drawings wherein:

FIG. 1 is a simplified schematic plan view of an automated sample handling system including a conveyor controlled in cooperation with several chemical analysis pre-treatment devices and analyzers in which the present invention may be employed advantageously.

### DETAILED DESCRIPTION OF THE PREFERRED EMBODIMENTS

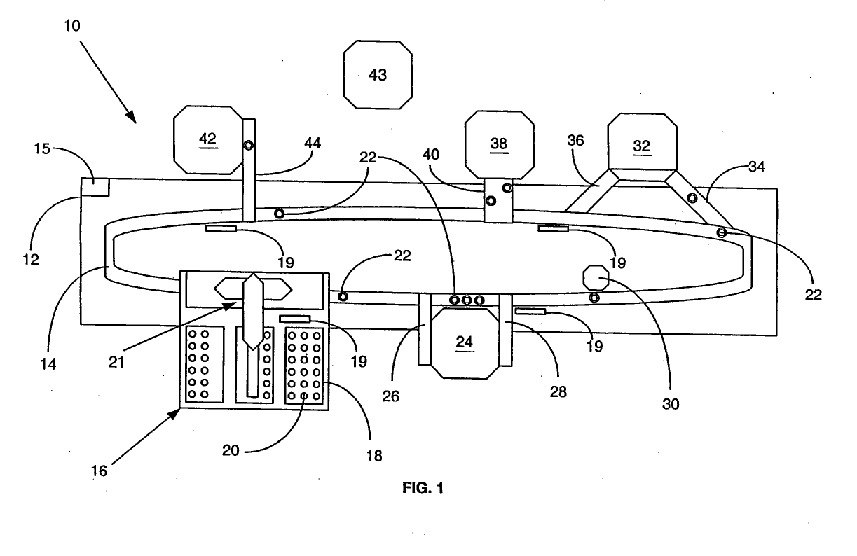

FIG. 1 shows an automated clinical chemistry sample handling workcell 10 capable of automatically pre-processing multiple sample containers 20, typically sample test tubes 20, contained in multiple sample racks 18 prior to analysis by an analyzer 32, 38 or 42. Typically, specimens to be automatically processed are provided to sample handling workcell 10 in capped containers 20. Each of the sample containers 20 is provided with identification indicia, such as a bar code, machine readable by a sensor 19 and indicating a patient's identification as well as the assay procedures to be accomplished upon the sample therein. The containers 20 are generally held in racks 18 that have additional identification indicia thereon.

Sample handling workcell 10 comprises an operating base 12 upon which a belt-like conveyor track 14 transports individual sample tube containers 20 carried in sample container carriers 22 from a sample container loading/unloading station 16, having more than one rack 18 for reasons discussed later, as well as active input lanes, to an automated centrifuge 24, therefrom to an automated tube de-capper 30 for automatically removing caps from capped sample containers 20 and therefrom to one or more analyzers 32, 38, and 42 before returning each sample container 20 to the sample tube loading/unloading robotic station 16. It should be understood that more than three analyzers 32, 38, and 42 may be linked by conveyor track 14; for purposes of simplicity, only three are shown. A remote analyzer 43 may be serviced by workcell 10 even though the remote analyzer 43 is not directly linked to workcell 10, for instance by an independent robotic system. The sample handling workcell 10 has a number of sensors 19 for detecting the location of a sample tube container 20 by means of identifying indicia placed on or within each sample tube carrier 22. Conventional bar-code readers may be employed in such tracking operations.

Centrifuge 24 and each analyzer 38, 42 and 32 are generally equipped with various robotic mechanisms 26 and 28, 40 and 44 or tracks 34 and 36, respectively, for removing a sample tube carrier 22 from track 14, moving the sample tube carrier 22 to and from centrifuge 24, to and from or into and out from analyzers 38, 42 and 32, respectively. Typically, the loading/unloading station 16 includes at least two X-Y-Z robotic arms 21 conventionally equipped with robotic clamping hands.

Sample handling workcell 10 is controlled by a conventionally programmed computer 15, preferably a microprocessor based central processing unit CPU 15, housed as part of or separate from the system 10 to control movement of the sample tube carrier 22 to each operating station 24, 30, 32, 38, 42 and 16 whereat various types of assay processing occurs, as described below. CPU 15 controls sample handling system 10 according to software, firmware, or hardware commands or circuits like those used on the Dimension® clinical chemistry analyzer sold by Dade Behring Inc. of Deerfield, Ill., and are typical of those skilled in the art of computer-based electromechanical control programming.

The present invention may be implemented using a computer interface module CIM that allows for a user to easily and quickly access a variety of control screens and status information display screens that fully describe a plurality of interrelated automated devices used for sample preparation and clinical analysis of a patient's biological sample. Such a CIM preferably employs a first display screen that is directly linked to a plurality of additional display screens containing on-line information about the operational status of plurality of interrelated automated devices as well as information describing the location of any specific sample and the status of clinical tests to be performed on the sample. The CIM is thus adapted to facilitate interactions between an operator and automated clinical analytical system 10 wherein the module comprises a visual touch screen adapted to display a menu including icons, scroll bars, boxes and buttons through which the operator may interface with the clinical analytical system and wherein the menu comprises a number of function buttons programmed to display functional aspects of the clinical analytical system.

In the instance described hereinabove wherein analyzer 32 is, for example, a clinical chemistry analyzer 32 and analyzer 38 is a coagulation analyzer, as also mentioned, different centrifuge protocols must be established within centrifuge 24 in order to provide a properly pre-assay treated sample for testing by chemistry analyzer 32 or by coagulation analyzer 38. As previously mentioned, sample containers 20 are provided with identification indicia readable by sensor 19 indicating the assay procedures to be accomplished upon the sample therein. Computer 15 is programmed to determine whether an assay is a clinical chemistry analysis or a coagulation analysis and which analyzers 32, 38 and 42 are adapted to perform such analyses.

The present invention is a method for managing the different processes involved in handling samples that require differential centrifuging protocols within a clinical sample handling workcell 10. As previously explained, combining both clinical chemistry and coagulation test samples on a single workcell 10 requires segregation of clinical chemistry and coagulation samples during the sample preparation process due to the aforementioned differential centrifuging protocols, involving either different spin rates or lengths of time or both. In one embodiment, these needs may be satisfied by providing a first centrifuge for pre-treating samples for subsequent clinical chemistry analysis and a second centrifuge for pre-treating samples for subsequent coagulation analysis. Alternately, discrete sample batches may be processed within a single centrifuge 24 having first and second operating protocols, respectively adjusted for subsequent clinical chemistry and coagulation analysis. Another alternative is for the laboratory to validate a set of centrifuge protocols that properly separate both chemistry and coagulation samples. The present invention is applicable in any of the above alternative situations.

The inventive method provides for detection and classification of coagulation and chemistry samples at the loading/unloading station 16 of workcell 10 and permitting only those samples in containers 20 that have centrifuging requirements which match the currently established centrifuge operating protocols, adjusted to preparing sample for either chemistry and/or coagulation to be placed on belt 14 by robotic arms 21 for processing and analysis. If a sample in a container 20 does not have centrifuging requirements which match the currently established centrifuge operating protocols, container 20 is replaced back into an available input rack 18 at station 16 and retained there until the centrifuge operating protocols are changed appropriately. If a sample in a container 20 does have centrifuging requirements which match the currently established centrifuge operating protocols, sample container 20 is placed onto belt 14 by loading/unloading station 16 and is subsequently processed in a routine manner by centrifuge 24 and then by either chemistry analyzer 32 or coagulation analyzer 38 depending upon whether centrifuge 24 is being operated with centrifuge protocols for chemical or coagulation testing. To determine if a container 20 has centrifuging requirements which match the currently established centrifuge operating protocols, the identification indicia on a sample container indicating the assay procedures to be accomplished upon the sample therein are read by sensor 19 and this information is employed to make such a determination.

When all samples in containers 20 in a rack 18 having centrifuging requirements which match the currently established centrifuge operating protocols have either been placed upon belt 14 in accord with the present invention or replaced into a rack 18 as a consequence of having centrifuging requirements that do not match the currently established centrifuge operating protocols, also in accord with the present invention. Containers 20 placed upon belt 14 are conveyed by belt 14 to centrifuge 24 whereat the appropriate centrifuge protocol is conducted on the sample within container 20. Any containers 20 replaced into rack 18 as a consequence of having centrifuging requirements that do not match the currently established centrifuge operating protocols will be included within the next batch of samples to be subjected to centrifugation only after the centrifuge operating protocols are adjusted appropriately. This present invention thereby produces as close to a first-in-first-out processing order as can be achieved when there are conflicting centrifuging requirements.

Obviously, if the chemistry and coagulation analyzers have common centrifuging requirements then segregation of samples is not required and both clinical chemistry & coagulation samples may be intermixed within a single centrifuge batch.

If there is more than one centrifuge 24 in workcell 10, for example device 42 also being a centrifuge, the present invention creates dedicated centrifuge batches for each of the multiple centrifuges with each centrifuge 24 being adapted to properly prepare clinical chemistry or coagulation samples by repeating the process described above for each different centrifuge. Depending on variety of samples being provided to workcell 10, it may thus be possible to have any combination of centrifuge batches being formed; for example, if both devices 24 and 42 are centrifuges, creating a two centrifuge workcell, then, as an example only, centrifuge 24 may be set up to process clinical chemical samples and centrifuge 42 set up to process coagulation samples, or both centrifuges 24 and 42 may be set up to process clinical chemical samples, or both centrifuges 24 and 42 may be set up to process coagulation samples, or centrifuge 24 may be set up to process coagulation samples and centrifuge 42 set up to process chemistry samples. Such flexibility maximizes throughput of workcell 10 when the incoming sample load has a much greater content of either chemistry or coagulation samples. Clearly also, such an arrangement minimizes the affect of a single centrifuge failure.

As an example of the present invention, consider an instance wherein each device 32, 38 and 48 is setup and controlled by computer 15 to define the “Centrifuge Protocol set” required so that a sample is properly prepared for processing thereby. Exemplary values are “Chemistry” and “Coagulation”. Conventional clinical chemistry analyzers would be setup as “Chemistry”, while conventional coagulation analyzers would be assigned the value “Coagulation”. Thus a Centrifuge Parameter set={Chemistry, Coagulation} is defined.

Centrifuge 24 would thusly set up and controlled by computer 15 to maintain separate centrifugation protocols for each “Centrifuge Parameter set”. For example, a “Chemistry Centrifuge Parameter set” might specify a spin rate of 2,700 rpm for ten minutes while a “Coagulation Centrifuge Parameter set” might specify a spin rate of 3,000 rpm for twelve minutes.

In addition, it may be desirable to have different centrifuging protocols for urine specimens vs. serum/plasma specimens; thus, the centrifuging requirements may be different for different sample fluids being processed. It is further foreseen that it may desirable to have different centrifuging protocols for urine vs. serum/plasma specimens for instance. It may also be possible that the centrifuging protocols may be for samples to be processed in a user defined analyzer, selected from the analyzers 32, 38, 42 and 43, for example.

Furthermore, it may be required to centrifuge certain coagulation samples more than one time before the sample can be presented to an analyzing device for analysis, in the event of sensitive coagulation assays like Protein S and other that are within this category. Thus, the centrifuging protocols may be different for different sample fluids based on the specific ordered assay.

As explained above, in accord with the present invention, if the centrifuge protocols for Chemistry and Coagulation do not match one another, the samples to be processed by, for example, chemistry analyzer 32 or coagulation analyzer 38 will not be allowed to be centrifuged by centrifuge 24 at the same time.

When a batch of samples in containers 20 have been transported by belt 24 to centrifuge 24, robotic devices 26 and 28 place containers into centrifuge bucket inserts and the inserts are placed in centrifuge 24. The “Coagulation Centrifuge Protocol” currently defined will be saved by computer 15 to eliminate any potential errors resulting in a change in operating protocols requested by an operator while containers 20 are being processed. Likewise whenever a centrifuge batch is started, a “process log”, either manually maintained or automatically recorded within computer 15 will include an entry indicating whether the Chemistry or Coagulation protocols are used. If both the Chemistry and Coagulations centrifuging conditions are identical, this “Centrifuge Parameter set” log entry may be omitted.

As a more detailed illustration of the present invention, consider an instance wherein the required Chemistry and Coagulation centrifuging protocols are different. As input racks 18 are pushed into the loading/unloading robotic station 16, they are queued in order. The first rack 18 to be processed establishes whether a Chemistry or Coagulation centrifuge batch will be started based on its contents. Operators load each rack 18 only with only chemistry sample containers 20 or only with coagulation sample containers 20 to improve overall processing efficiencies. The following processing steps are implemented and controlled by computer 15
1. System 10 is idle (no racks 18 on workcell 10)
2. An operator inserts several racks 18 of containers 20 into dynamic lanes within the loading/unloading robotic station 16
3. Rack IDs are read and racks 18 are queued up for processing
4. First container 20 removed from an input rack 18 is identified to be classified as a Chemistry sample
5. First rack 18 becomes affiliated with a Chemistry centrifuge batch
6. Successive containers 20 are removed from rack 18 and sent to centrifuge 24
7. When the first rack 18 is emptied, the next queued input rack 18 is unloaded.
   i. If the first container 20 removed from said next queued input rack 18 is not a chemistry sample (i.e., all ordered tests are identified as being coagulation tests), container 20 is returned to rack 18 and rack 18 then becomes affiliated with a Coagulation centrifuge batch.
   ii. If the first container 20 removed from said next queued input rack 18 is a chemistry sample it is placed on conveyor track 14 and delivered to centrifuge 24 and each container 20 in turn from that rack 18 is likewise processed.
8. When the all chemistry containers 20 have been removed from the queued input racks 18 or the centrifuge buckets are full, the centrifuge batch is spun.
9. Each time a centrifuge batch starts, the loading/unloading robotic station 16 is controlled by computer 15 to proceed to the oldest queued input rack 18 to prepare a new centrifuge batch.
   i. If racks 18 with coagulation samples therein were previously examined then such racks 18 are loaded to form a Coagulation centrifuge batch.
   ii. If no racks 18 or containers 20 were previously examined and bypassed, then the next centrifuge batch would be determined by the next queued input container 20 picked up for processing.

Following the above exemplary illustration of the present invention, the outcome of an instance involving seven racks 18 inserted into the loading/unloading robotic station 16 in this order:
1) Rack 1 with 48 Chemistry samples
2) Rack 2 with 36 Coagulation samples
3) Rack 3 with 48 Chemistry samples
4) Rack 4 with 48 Chemistry samples
5) Rack 5 with 48 Coagulation samples
6) Rack 6 with 30 Chemistry samples
7) Rack 7 with 10 Coagulation samples

In accord with the present invention, system 10 would be operated as follows:
1) Centrifuge batch 1
   80 Chemistry samples
      48 from Rack 1
      00 from Rack 2 (coagulation samples)
      32 from Rack 3
2) Centrifuge batch 2
   80 Coagulation samples
      36 from Rack 2
      00 from Rack 3 (chemistry samples)
      00 from Rack 4 (chemistry samples)
      44 from Rack 5
3) Centrifuge batch 3
   80 Chemistry samples
      16 from Rack 3
      48 from Rack 4
      00 from Rack 5 (coagulation samples)
      18 from Rack 6
4) Centrifuge batch 4
   14 Coagulation samples
      04 from Rack 5
      00 from Rack 6 (coagulation samples)
      10 from Rack 7
5) Centrifuge batch 5
   12 Chemistry samples
      12 from Rack 6

If an operator intermixes chemistry and coagulation containers 20 in a single rack 18 that is placed in a dynamic input lane 18, any containers 20 that are returned to the rack 18 as not matching the rack affiliation (chemistry/coagulation) will be processed later. In the example above if two chemistry containers 20 had been mixed in with the containers 20 in Rack 5 the centrifuge batch outcome would have changed as follows:
Alternate step 4) Centrifuge batch 4
   12 Coagulation samples
      02 from Rack 5
      Remaining 02 samples in Rack 5 are Chemistry samples
      00 from Rack 6 (chemistry samples)
      10 from Rack 7
Alternate step 5) Centrifuge batch 5
   14 Chemistry samples
      02 from Rack 5
      12 from Rack 6

If there is a Priority Input feature within the loading/unloading robotic station 16, the present invention operates in a similar fashion. When a STAT rack 18 is inserted the robot 21 will interrupt processing containers 20 from normal input racks 18. If the STAT sample matches the current centrifuge batch, it will be sent to centrifuge 24. If it does not match, it will be returned to the priority input STAT rack 18 for processing in the next available centrifuge batch. It is possible that both chemistry and coagulation containers 20 could be waiting in a priority input rack for the next centrifuge batch. In this case the oldest tube in the priority input racks would establish what centrifuge batch to start next.

It should be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. For example, the functions of computer 15 could be distributed among independently operable devices 16, 24, 32, 38 and 42, the exemplary centrifuging conditions could be changed, the layout of workcell 10, and the like, could be altered without departing from the substance or scope of the present invention. It is also envisioned by the present invention that the centrifuging protocols are for samples to be processed in a remote analyzer 43 not connected to the workcell 10 and are removed from workcell 10 and analyzed in the remote analyzer 43. It is further envisioned by the present invention that the centrifuging requirements are for samples that do not have test orders allowing for a specific assay classification.

Accordingly, while the present invention has been described herein in detail in relation to specific embodiments, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A method for operating an automated clinical sample workcell having a sample conveyor connecting two or more analyzers and at least one centrifuge operated by a first centrifuging protocol to a sample input station by:
classifying samples at the input station in accord with the tests to be performed thereon and the associated centrifuging requirements;
transporting to the centrifuge only those samples that have centrifuging requirements that are the same as the first centrifuging protocol; and,
centrifuging the sample in accord with the first centrifuging protocol by the centrifuge.

2. The method of claim 1 further comprising:
retaining samples with centrifuging requirements in accord with a second protocol wherein the second protocol does not match the first protocol at the input station;
changing the centrifuge operation to the second protocol;
transporting the retained samples to the centrifuge; and,
centrifuging the samples in accord with the second protocol by the centrifuge.

3. The method of claim 2 wherein the first centrifuging protocol is for samples to be processed in a chemical analyzer.

4. The method of claim 2 wherein the second centrifuging protocol is for samples to be processed in a coagulation analyzer.

5. The method of claim 2 wherein the first and second centrifuging protocols are identical, the method comprising:
placing all samples on the conveyor; and,
centrifuging all samples by the centrifuge.

6. The method of claim 1 further comprising operating the conveyor to deliver the sample to the analyzer adapted to perform the tests to be performed

7. A method for operating an automated clinical sample workcell having a sample conveyor connecting two or more analyzers and two or more centrifuges operated by a first centrifuging protocol to a sample input station by:
classifying samples at the input station in accord with the tests to be performed thereon and the associated centrifuging requirements;
transporting to any one of the centrifuges only those samples that have centrifuging requirements that are the same as the first centrifuging protocol; and,
centrifuging the sample in accord with the first centrifuging protocol by the centrifuge.

8. The method of claim 1 further comprising:
retaining samples with centrifuging requirements in accord with a second protocol wherein the second protocol does not match the first protocol at the input station;
changing the centrifuge operation of one centrifuge to the second protocol;
transporting the retained samples to said one centrifuge; and,
centrifuging the samples in accord with the second protocol by said one centrifuge.

9. A method for operating an automated clinical sample workcell having a sample conveyor connecting two or more analyzers, a first centrifuge operated by a first centrifuging protocol and a second centrifuge operated by a second protocol to a sample input station by:
classifying samples at the input station in accord with the tests to be performed thereon and the associated centrifuging requirements;
transporting to the first centrifuge only those samples that have centrifuging requirements that are the same as the first centrifuging protocol;
transporting to the second centrifuge only those samples that have centrifuging requirements that are the same as the second centrifuging protocol;
centrifuging the samples in accord with the first centrifuging protocol by the first centrifuge; and,
centrifuging the samples in accord with the second centrifuging protocol by the second centrifuge.

10. An automated clinical sample workcell comprising:
a sample container loading/unloading station;
at least one centrifuge having first and second centrifuging protocols;
at least two analyzers;
a conveyor adapted to transport sample containers from said sample container loading/unloading station to said centrifuge and from said centrifuge to said analyzers;
identification means for determining tests to be performed upon samples contained within said sample containers;
means for determining centrifuging requirements for the tests to be performed upon samples contained within said sample containers;
control means for determining if the centrifuging requirements match said first or second centrifuging protocols;
means for converting the centrifuge between said first and second centrifuging protocol to match said first or second centrifuging protocols.

11. The workcell of claim 10 wherein the sample container loading/unloading station is adapted to retain a sample container therein until the centrifuge is converted between said first and second centrifuging protocol to match said first or second centrifuging protocols.

12. An automated clinical sample workcell comprising:
a sample container loading/unloading station;
a first centrifuge having a first centrifuging protocol;
a second centrifuge having a second centrifuging protocol; at least two analyzers;
a conveyor adapted to transport sample containers from said sample container loading/unloading station to said centrifuge and from said centrifuge to said analyzers;
identification means for determining tests to be performed upon samples contained within said sample containers;
means for determining first and second centrifuging requirements for the tests to be performed upon samples contained within said sample containers;
control means for transporting samples having first centrifuging requirements to the first centrifuge and for transporting samples having second centrifuging requirements to the second centrifuge

13. The method of claim 1 wherein the centrifuging requirements are requirements for samples based on the sample fluid being processed.

14. The method of claim 1 wherein the centrifuging requirements are requirements for samples based on the assay to be performed on said sample.

15. The method of claim 1 wherein the centrifuging requirements are for samples to be processed in an analyzer not connected to the workcell.

16. The method of claim 1 wherein the centrifuging requirements are for samples to be processed in a user defined analyzer.
